(19) United States
(12) Patent Application Publication
(10) Pub. No.: US 2019/0283352 A1
(43) Pub. Date: Sep. 19, 2019

(54) Venting Unit for a Vulcanization Mold of a Vehicle Pneumatic Tire

(71) Applicant: Continental Reifen Deutschland GmbH, Hannover (DE)

(72) Inventors: Magnus Hasselloef, Hemmingen (DE); Juergen Dzick, Seelze (DE)

(21) Appl. No.: 16/307,906

(22) PCT Filed: May 8, 2017
(86) PCT No.: PCT/EP2017/060853

§ 371 Date: Dec. 6, 2018

(30) Foreign Application Priority Data
Jun. 6, 2016 (DE) 102016209910.8

(51) Int. Cl. B29D 30/06; B29C 33/10

(52) U.S. Cl. CPC B29D 30/0606; B29D 2030/0617; B29C 33/10

(57) ABSTRACT

Venting unit for a vulcanizing mold of a pneumatic vehicle tire, having a central longitudinal mid-axis (a), a cylindrical housing, and a valve insert, which is positioned in the housing and is movable relative thereto and has a valve shank with a valve disk and has a helical compression spring, which surrounds the valve shank and is supported with its one end on the housing and with its other end on the valve disk, it being possible for the housing to be anchored in a venting bore of the vulcanizing mold by a press fit. The housing can be anchored in the venting bore by a press fit just over 30% to 45% of the housing length and at least directly at the outer end of the venting bore.

### CROSS REFERENCE TO RELATED APPLICATIONS

This application is the national stage of PCT/EP2017/060853, filed May 8, 2017, designating the United States and claiming priority from German patent application no. 10 2016 209 910.8, filed Jun. 6, 2016, the entire contents of which are incorporated herein by reference.

### FIELD OF THE INVENTION

The invention relates to a venting unit for a vulcanizing mold of a pneumatic vehicle tire, having a central longitudinal mid-axis, a cylindrical housing and a valve insert, which is positioned in the housing and is movable relative thereto and has a valve shank with a valve disk and has a helical compression spring, which surrounds the valve shank and is supported with its one end on the housing and with its other end on the valve disk, it being possible for the housing to be anchored in a venting bore of the vulcanizing mold by a press fit.

### BACKGROUND OF THE INVENTION

It is known and customary that in vulcanizing molds for pneumatic vehicle tires, in particular for passenger cars, there are on average approximately 4500 venting bores, with the same number of venting units inserted in them. The venting units contain valve inserts, the valve disks of which close the venting bores on the molded green tire and at least largely prevent the occurrence of rubber flash during the vulcanization of the tire. During the molding of the green tire, the valve inserts are open and the valves disks protrude on the inner side of the mold, so that the required venting can take place during the molding of the green tire.

A venting unit of the type mentioned at the beginning is known for example from EP 0 774 333 B1. The cylindrical housing of this known venting unit has an outer diameter which is adapted to the inner diameter of the venting bore in such a way that the complete housing of the venting unit can be inserted into the respective venting bore by a press fit. Relatively high forces must be exerted for this purpose, only allowing manual fastening of the venting units in the venting bores. This way of anchoring the venting units, involving expenditure of great force, can lead to the walls of the bores being damaged, in particular if the venting units are inadvertently inserted off-center.

Furthermore, the high forces to be applied for inserting the venting units often do not allow exact and accurate positioning of the housing in relation to the inner side of the mold, which however is required to ensure satisfactory functioning of the venting units and optimum formation of the outer side of the tread of the pneumatic vehicle tire.

### SUMMARY OF THE INVENTION

It is an object of the invention to improve a venting unit of the type mentioned at the beginning in this respect, in particular in order to ensure exact and optimum fitting of the venting units in the venting bores and in order to allow the venting units also to be inserted with an automatically actuated tool.

The stated object can, for example, be achieved via the housing being able to be anchored in the venting bore by a press fit just over 30% to 45% of the housing length and at least directly at the outer end of the venting bore.

It has been found that it is sufficient for a secure fit of the housing of the venting unit in the venting bore to anchor the housing in the venting bore wall by a press fit just over a portion of its extent in the venting bore. The pressing in consequently requires a much lower expenditure of force than the pressing in of venting units according to the prior art. As a result, damage to the walls of the bore can be effectively avoided, the time expended for insertion is much less and there is also the possibility of being able to insert venting units into the venting bores automatically with a corresponding tool.

In the case of an embodiment of the invention, the housing can be anchored in the venting bore by a press fit via a single outer cylindrical portion that extends over 30% to 45% of the housing length. This particularly expedient embodiment of the housing can also be produced particularly easily.

In the case of an alternative variant of the embodiment, the housing can be anchored in the venting bore by a press fit via a number of cylindrical portions extending altogether over 30% to 45% of the housing length. This variant offers the advantage of distributing the press fitting surfaces over a greater region of the housing.

In the case of this alternative variant of the embodiment, one of the cylindrical portions is a peripheral portion which runs around the outer end of the housing and the length of which is at least 1.0 mm.

Of particular advantage is an embodiment of the housing in which it has a cylindrical portion which directly adjoins its inner end and the outer diameter of which is smaller than the outer diameter of that portion or those portions via which the housing can be anchored in the venting bore by a press fit. It is particularly advantageous in this case if the inner cylindrical portion has a length of at least 30% of the housing length. With this portion, the housing can be prepositioned in the venting bore in a centered manner. It is therefore of advantage if the inner cylindrical portion has an outer diameter that is less by 0.2 mm to 0.5 mm than that portion or those portions via which the housing can be anchored in the venting bore by a press fit.

In the case of an embodiment of the housing with multiple cylindrical portions that can be anchored in the venting bore by a press fit, a further portion is respectively provided between these portions, the outer diameter of which is smaller than the outer diameter of the outer portions and in particular corresponds to the outer diameter of the inner portion.

In order to avoid catching of the housing on the periphery of the venting bore on the inner side of the mold at the transitional region from the inner portion to the adjoining outer portion of the housing, these portions are preferably connected to one another by way of a peripheral sloping surface, which runs at an angle of 10° to 60°, in particular at an angle of 15° to 45°, in relation to the longitudinal mid-axis of the venting unit.

The pre-positioning of the housing by inserting the inner portion into the venting bore can be facilitated by a sloping surface which is provided on the outside at the inner end of the inner portion of the housing and which runs at an angle of 10° to 60°, in particular at an angle of 15° to 45°, in relation to the longitudinal mid-axis of the venting unit.

### BRIEF DESCRIPTION OF THE DRAWINGS

The invention will now be described with reference to the drawings wherein:

FIGS. 1A and 1B schematically show sectional representations of a partial region of a mold segment of a vulcanizing mold;

FIG. 2 shows a longitudinal section of a variant of the embodiment of a venting unit;

FIG. 3A and FIG. 4 show sectional representations of individual component parts of the venting unit according to FIG. 2, FIG. 3B shows a variant of FIG. 3A; and,

FIG. 5 and FIG. 6 show variants of the embodiment of the configuration of a valve disk.

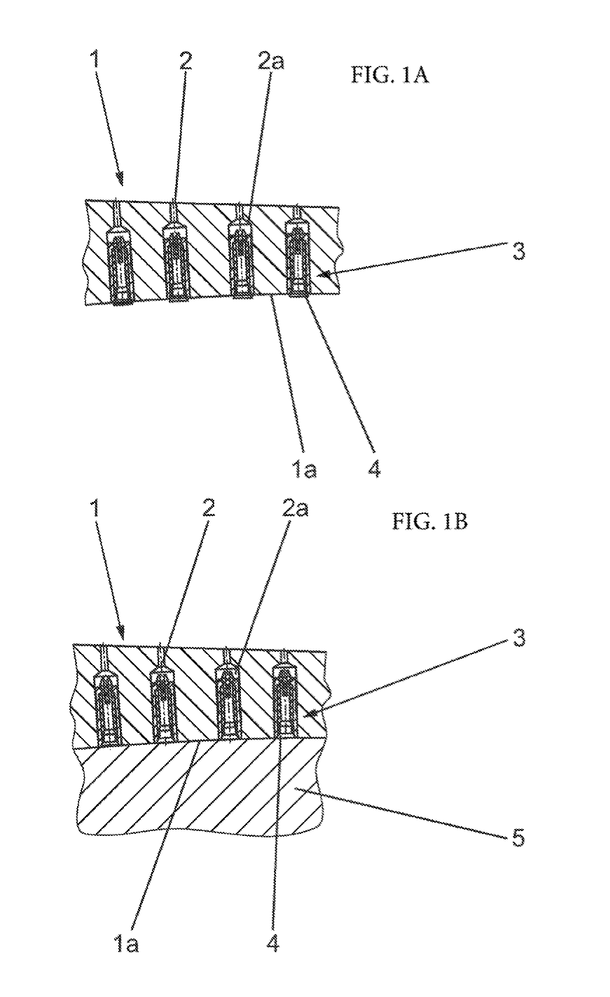

FIGS. 1A and 1B show sectional representations of part of a mold segment 1 of a vulcanizing mold which is radially divided in the usual way by the part forming the tread region into a number of mold segments, in particular between seven and thirteen mold segments being provided. The sections through the mold segment 1 also show a number of longitudinal sections through venting bores 2, which are oriented in the radial direction and, in the case of the embodiment shown, respectively have on the mold segment inner side 1a a portion 2a with a greater diameter. In each portion 2a, a venting unit 3 is inserted. In the representation shown in FIG. 1A—without the molded green tire—the venting units 3 are all open, spring-loaded valve disks 4 projecting slightly beyond the mold segment inner side 1a and protruding into the vulcanizing mold cavity. In a manner of representation analogous to FIG. 1A, FIG. 1B shows the moment where, toward the end of the molding of a green tire, a part thereof that is forming the tread 5 has come into contact with the mold segment inner side 1a, so that the raw tread 5 have pressed the valve disks 4 into the closed position that is shown in FIG. 1B.

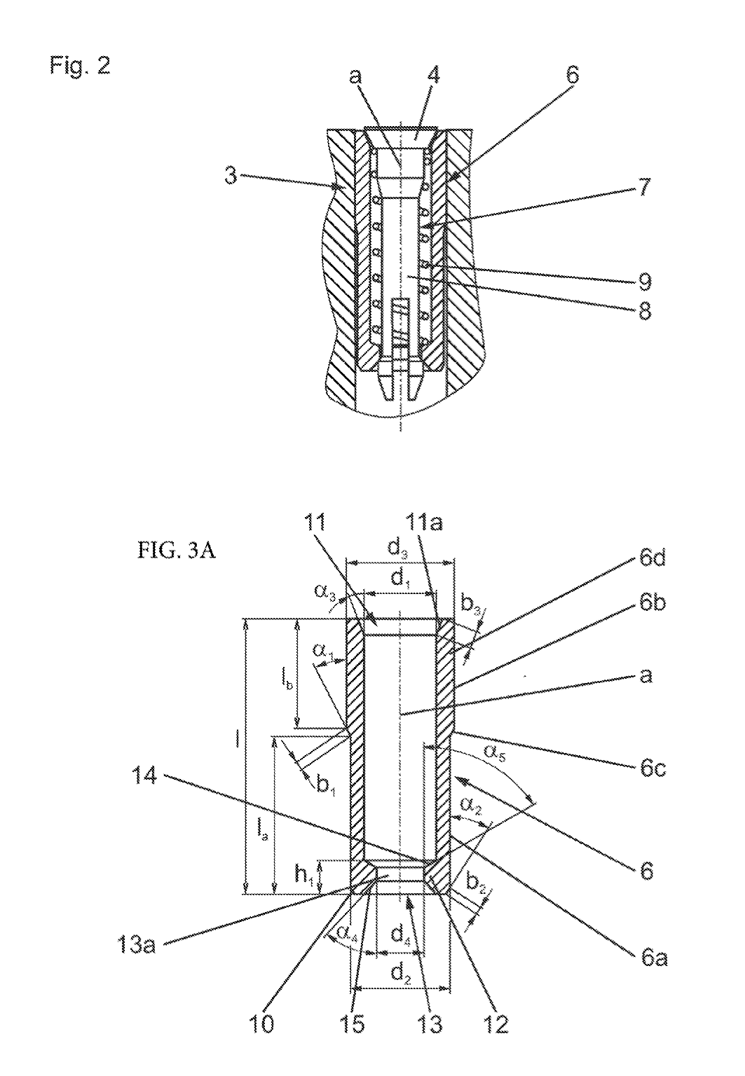

FIG. 2 shows in the same sectional plane as FIGS. 1A and 1B, in an enlarged representation, an individual venting unit 3, which a housing 6, a valve insert 7 comprising a valve shank 8 and the already mentioned valve disk 4 and also a helical compression spring 9, which surrounds the valve shank 8 and is supported with its one end on the housing 6 and with its other end on the underside of the valve disk 4. The venting unit 3 has a longitudinal mid-axis a, which runs in its longitudinal extent—in mold segments that form the tread this corresponds to the radial direction in the tire—with respect to which most of the component parts of the venting unit 3 are embodied rotationally symmetrically. The longitudinal mid-axis a of the venting unit 3 is therefore at the same time the longitudinal mid-axis a of the housing 6 and of the valve insert 7.

In the following detailed description of individual component parts of the venting unit 3, the configuration of these component parts is considered with reference to their installation position in the mold segment 1 or the position in the figures; this concerns for example designations such as outer or upper and inner. The venting unit represented is, by way of example, a venting unit with a diameter of 3.2 mm, therefore a venting unit for vulcanizing molds for car tires. Usually, venting units can have a diameter (diameter adapted to the venting bore) of 2 mm to 5 mm.

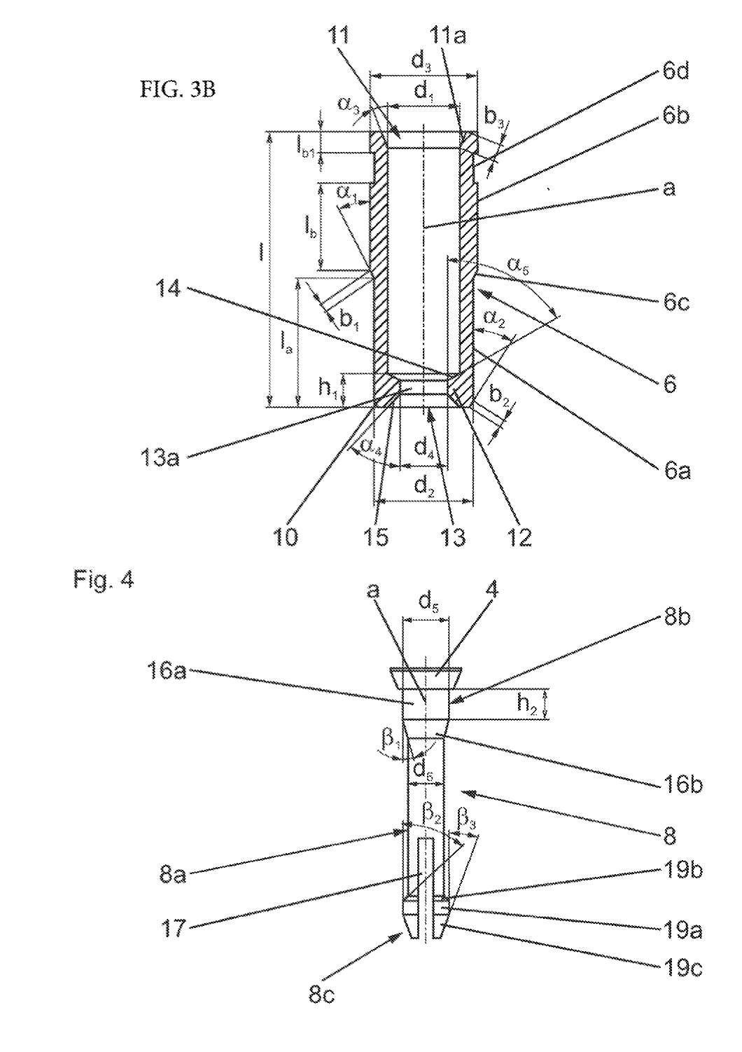

The housing 6 that is shown separately in FIGS. 3A and 3B is substantially a cylindrical sleeve with a constant inner diameter d₁ over the majority of its extent along the longitudinal mid-axis a. The housing 6 has on its outer side an inner portion 6a, which reaches up to the inner-side end of the housing 6 and has a length lₐ, which is at least 35% of the housing length l. The portion 6a has an outer diameter d₂, which is smaller by at least 0.3 mm, in particular by up to 0.5 mm, than the inner diameter of the bore portion 2a. In the case of both variants of the embodiment, the inner portion 6a goes over into a further portion 6b via a sloping surface 6c running around the housing 6. In the case of the embodiment shown in FIG. 3A, the further portion 6b extends up to the outer or upper end of the housing 6. In the case of the embodiment shown in FIG. 3B, the upper end of the housing 6 is adjoined by a narrow peripheral portion 6b₁, which is separated from the portion 6b by a narrow portion 6d that runs around the housing 6 and is configured in cross section in the manner of a groove, the outer diameter of the portion 6d corresponding in particular to the outer diameter d₂ of the inner portion 6a. The peripheral portion 6b₁ has a length lb₁ of at least 1.0 mm. Both the portion 6b (FIG. 3A, FIG. 3B) and the peripheral portion 6b₁ (FIG. 3B) have an outer diameter d₃, which is greater by 0.3 mm to 0.5 mm than the outer diameter of the portion 6a and is adapted to the inner diameter of the portion 2a of the venting bore 2 in such a way that the portion 6b (FIG. 3A) or the latter and the peripheral portion 6b₁ (FIG. 3B) can be pressed into the venting bore 2. The portion 6b or the portions 6b and 6b₁ extends or extend altogether over a length l_{b} (FIG. 3A) or l_{b}+lb₁ (FIG. 3B) of 30% to 45 of the housing length l. The housing 6 may furthermore have more than two portions, the outer diameter of which is adapted in the way mentioned to the inner diameter of the venting bore 2. The sloping surface 6c running around the outside of the housing 6, between the inner portion 6a and the adjoining portion 6b, runs at an angle α₁ of 10° to 60°, in particular of 15° to 45°, in relation to the outer side of the portion 6b or in relation to the longitudinal mid-axis a. The width b₁ of the sloping surface 6c is for example of the order of magnitude of 0.20 to 0.30 mm.

A further sloping surface 10 with an inward inclination is formed on the outside at the inner end of the housing 6. The sloping surface 10 is a kind of bevel on the edge of the housing and runs at a constant angle α₂, which is 10° to 60°, in particular 15° to 45°, in relation to the outer side of the portion 6a or in relation to the longitudinal mid-axis a. The sloping surface 10 is very narrow; its width b₂ is of the order of magnitude of 0.15 to 0.20 mm.

On the outer end region, facing the mold segment inner side 1a, the housing 6 is provided on the inside with a widening 11 in the form of a truncated cone, which is adapted to the configuration of the valve disk 4, which, as for example FIG. 2 shows, is likewise configured in the form of a truncated cone. The widening 11 is accordingly formed by a sloping surface 11a, which runs around the inside on the periphery of the housing 6 and runs at an angle α₃ of 10° to 45°, preferably 15° to 30°, in particular 22°, in relation to the longitudinal mid-axis a. The width b₃ of the sloping surface 11a is of the order of magnitude of 0.5 mm.

On the end region of the housing 6 that is opposite from the widening 11 in the form of a truncated cone there is a housing base 12, which has a middle circular opening 13 with a central narrowest opening portion 13a, the inner diameter d₄ of which is smaller than the inner diameter d₁ of the housing 6 and is surrounded by a narrow ring. Above and below the opening portion 13a, the opening 13 is widened via a respective sloping surface 14, 15. The sloping surface 15 running on the outside of the housing base 12 runs at an angle of α₄ of 30° to 60°, in particular of approximately 45°, in relation to the longitudinal mid-axis a. On the inside of the housing, the second sloping surface 14 in the case of the embodiment shown forms a transitional surface with respect to the housing inner wall and runs at an angle α₅ of 30° to 70°, in particular of the order of magnitude of 60°, in relation to the longitudinal mid-axis a. The height h₁ of the housing base 12 parallel to the longitudinal mid-axis a is of the order of magnitude of 0.4 mm to 0.6 mm.

The valve insert 7 is now described in more detail on the basis of FIGS. 2 and 4. FIG. 4 shows the valve shank 8, which is made up of a cylindrical base portion 8 a of a constant diameter, running over the majority of its extent, an end portion 8b, which is facing the mold segment inner side 1a and on which the valve disk 4 is located, and an end portion 8c, which is facing away from the mold segment inner side. The end portion 8b has a cylindrical holding portion 16a, which adjoins the valve disk 4 and has a height h₂ of 1.0 mm to 1.5 mm and the diameter d₅ of which is greater than the diameter d₆ of the base portion 8a and is adapted to the inner diameter of the helical compression spring 9 in such a way that the latter can be firmly fitted onto the holding portion 16a and support itself on the inside of the valve disk 4. As FIG. 2 shows, the helical compression spring 9 has at its end that can be fitted onto the holding portion 16a at least two narrowly spaced turns 9a, the mutual spacing of which in the relaxed state of the helical compression spring 9 corresponds to at most half, in particular at most a third, of the mutual spacing of the other turns. Such a “double turn” may also be provided at the second end of the helical compression spring 9. The diameter d₆ of the base portion 8a is adapted to the inner diameter d₄ of the opening portion 13a in the housing base 12. The diameter d₆ of the base portion 8a is smaller by at least 0.3 mm than the inner diameter of the helical compression spring 9. Between the base portion 8a and holding portion 16a there is a centering portion 16b, which is a sloping surface running around the end portion 8b and runs at an angle β₁ of 10° to 20°, in particular of the order of magnitude of 15°, in relation to the central longitudinal mid-axis a.

The second end portion 8c is divided into two in the middle by a slit 17 extending along the longitudinal mid-axis a and reaching into the base portion 8a. The slit 17 allows the two end portion parts 18a, 18b to be pressed together and moved apart, so that the valve shank 8 can be led through the constriction or the opening 13 in the peripheral projection 12 of the housing 6 and can in this way be fastened on the housing 6. Each end portion part 18a, 18b forms a projection, which according to the cylindrical form of the shank is in each case rounded overall. At its widest point, each projection has a collar 19a, which adjoins the base portion 8a via a sloping surface 19b. The sloping surfaces 19b run at an angle β₂ of 30° to 60°, in particular of 45°, in relation to the longitudinal mid-axis a, the angle N₂ preferably corresponding to the angle α₄ of the sloping surface 15 at the opening 13 in the housing base 12 of the housing 6, so that, as FIG. 2 shows, with the valve shank 8 inserted the sloping surface 19b supports itself on the sloping surface 15 of the housing 6. The end portion parts 18a, 18b taper in the direction of the end of the shank and have on the outer side sloping surfaces 19c, which respectively run at an angle β₃ of 15° to 25°, in particular of 20°, in relation to the longitudinal mid-axis a and form an insertion aid during the insertion of the valve shank 8 into the housing 6. As FIG. 2 shows, with the valve shank 8 inserted in the housing 6, the end portions 18a, 18b are below the opening 13.

To assemble the venting unit 3, the helical compression spring 9 is positioned over the valve shank 8 and the valve shank 8 is led through the middle opening 13 in the projection 12 of the housing while pressing together the two end portion parts 18a, 18b and in this way is fastened on the housing 6. The sloping surfaces 14 above the opening portion 13a and the sloping surfaces 19c on the valve shank 8 make insertion possible with little expenditure of force.

In the case of the embodiment shown in FIG. 2 and FIG. 4, the valve disk 4 is configured with a planar outer surface. However, at least one elevation and at least one depression may be formed on the surface of the valve disk, any surface region outside the elevation or depression remaining planar. The height of the elevation or elevations, in the vertical direction with respect to a plane containing the circular periphery of the valve disk, should preferably correspond to at most the lift of the valve shank 8. Elevations and depressions may be of almost any desired configuration, the depression(s) or elevation(s) preferably being arranged or formed symmetrically with respect to at least one plane that contains the central longitudinal mid-axis a. Elevations or depressions may be configured in the form of a cuboid, in plan view in the form of a star or in the form of a circle and the like. Elevations have either a rounded surface or an outer surface that runs parallel to the plane containing the circular periphery of the valve disk.

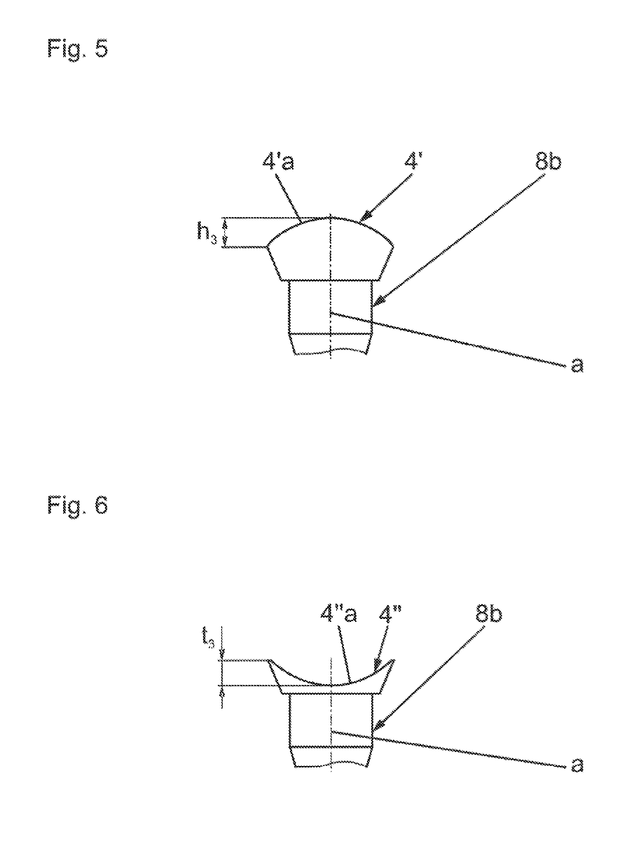

FIG. 5 and FIG. 6 show preferred variants of the embodiment of valve disks 4′, 4″ on the basis of a partial region of the end portion 8a of the valve shank 8. The valve disk 4′ according to FIG. 5 has as an elevation an outward curvature of the entire surface 4′a of the valve disk 4′; the valve disk 4″ according to FIG. 6 has as a depression an inward curvature of the entire surface 4″a. The curvatures may take the form of portions of a sphere, the height h₃ or depth t₁ of the portion of the sphere, with respect to the plane containing the circular periphery of the valve disk, corresponding to at most 30% of the radius of the sphere on which it is based and being at most 0.50 mm.

On the one hand, an elevation or a number of elevations on the valve disk can have the effect of assisting the movement of the valve disk into its closed position; on the other hand, elevations and/or depressions on the valve disk can have the effect that local depressions or elevations, which are perceived as being visually less disturbing than the impressions of valve disks with a flat surface, are specifically formed on the tread of the tire.

The venting unit 3 can be inserted in a precise and easy way into the portion 2a of the venting bore 2 of the mold segment 1. Since only the outer portion 6a of the housing 6 is pressed into the venting bore 2, the housing 6 is positioned with its thinner portion 6b in the venting bore 2. The sloping surface 10 at the lower end of the portion 6b assists easy insertion into the bore 2. As a result, it is possible also to insert the housing 6 by machine without having a perfect alignment of the device, for example a robot, in relation to the bore. The longer thinner portion 6b has the effect that the housing 6 is pre-adjusted in the bore 2 and is substantially parallel to the axis of the bore when the sloping surface 6c comes into contact with the periphery of the bore. Then the housing 6 is exactly centered and aligned straight, in order that the housing 6 is then introduced parallel to the axis of the bore, without damaging or asymmetrically widening the periphery of the bore. Therefore, not only is a particularly exact positioning of the venting unit 3 in the venting bore 2 made possible, but the expenditure of force is also reduced significantly. In principle, the venting unit 3 may be completely assembled from its parts before it is introduced into the venting bore. However, it is also possible first to introduce the housing 6 into the venting bore 2 and then to position the further parts in the housing 6.

It is understood that the foregoing description is that of the preferred embodiments of the invention and that various changes and modifications may be made thereto without departing from the spirit and scope of the invention as defined in the appended claims.

### LIST OF REFERENCE NUMERALS

1 . . . Mold segment
1a . . . Mold segment inner side
2 . . . Venting bore
2a . . . Portion
3 . . . Venting unit
4, 4′, 4″ . . . Valve disk
5 . . . Tread
6 . . . Housing
6b_{. . .} Peripheral portion
6a, 6b . . . . Portion
6c . . . Sloping surface
6d . . . Portion
7 . . . Valve insert
8 . . . Valve shank
8a . . . Base portion
8b, 8c . . . End portion
9 . . . Helical compression spring
9a . . . Turn
10 . . . Sloping surface
11 . . . Widening
11a . . . Sloping surface
12 . . . Housing base
13 . . . Opening
13a . . . Opening portion
14, 15 . . . Sloping surface
16a . . . Holding portion
16b . . . Centering portion
17 . . . Slit
18a, 18b . . . End portion part
19a . . . Collar
19b, 19c . . . Sloping surface
a . . . Longitudinal mid-axis
b₁, b₂, b₃ . . . Width
d₁, d₂, d₃, d₄, d₅, d₆ Diameter
1 . . . Housing length
lₐ, l_{b}, l_{b1} . . . Length
α₁, α₂, α₃, α₄, α₅ Angle (housing)
β₁, β₂, β₃ . . . Angle (shank)
h₁, h₂, h₃ . . . Height
t₁ . . . Depth

1-10. (canceled)

11. A venting unit for a vulcanizing mold of a pneumatic vehicle tire, the vulcanizing mode defining a venting bore having an outer end, the venting unit comprising:
a cylindrical housing defining a housing length (1);
a valve insert positioned in said housing and being movable relative to said housing;
the venting unit defining a central longitudinal mid-axis (a);
said valve insert having a valve shank with a valve disk and further having a helical compression spring;
said helical compression spring surrounding said valve shank and having a first end supported on said housing and a second end supported on said valve disk; and,
said housing being configured to be able to be anchored in the venting bore of the vulcanizing mold by a press fit, wherein said housing can be anchored in the venting bore by the press fit over 30% to 45% of said housing length and at least directly at the outer end of the venting bore.

12. The venting unit of claim 11, wherein said cylindrical housing is configured to be anchored in the venting bore by the press fit via a single outer cylindrical portion extending over 30% to 45% of said housing length.

13. The venting unit of claim 11, wherein said cylindrical housing is configured to be anchored in the venting bore by the press fit via a plurality of cylindrical portions extending altogether over 30% to 45% of said housing length.

14. The venting unit of claim 13, wherein:
said housing has an outer housing end; and,
one of said plurality of cylindrical portions is a peripheral portion running around said outer housing end and has a length (lb1) of at least 1 mm.

15. The venting unit of claim 11 wherein:
said cylindrical housing further has an inner housing end;
said cylindrical housing includes a plurality of housing portions including an inner cylindrical portion;
said cylindrical housing is configured to be anchored in the venting bore via at least one of said housing portions; and,
said inner cylindrical portion adjoins said inner housing end and defines an outer diameter which is smaller than an outer diameter of said at least one housing portion via which said cylindrical housing is configured to be anchored in the venting bore by the press fit.

16. The venting unit of claim 15, wherein said inner cylindrical portion has an inner cylindrical portion length (la) of at least 30% of said housing length (1).

17. The venting unit of claim 11, wherein:
said cylindrical housing includes a first cylindrical portion, a second cylindrical portion and a further portion;
said first cylindrical portion and said second cylindrical portion are configured to be anchored in the venting bore by the press fit;
said further portion has a further portion outer diameter and is provided between the cylindrical portions;
said first cylindrical portion and said second cylindrical portion each have cylindrical portion outer diameters; and,
said further portion outer diameter is smaller than said cylindrical portion outer diameters.

18. The venting unit of claim 15, wherein said inner cylindrical portion has an outer diameter that is less by 0.2 mm to 0.5 mm than said at least one of said housing portions via which said cylindrical housing is configured to be anchored in the venting bore by a press fit.

19. The venting unit of claim 11, wherein:
said cylindrical housing includes an inner portion, an outer portion directly adjoining said inner portion and a peripheral sloping surface;
said inner portion is connected to said outer portion of said cylindrical housing by way of said peripheral sloping surface;
said peripheral sloping surface runs at an angle (α1) of 10° to 60° in relation to the longitudinal mid-axis (a) of the venting unit.

20. The venting unit of claim 11, wherein:
said cylindrical housing includes an inner portion, an outer portion directly adjoining said inner portion and a peripheral sloping surface;
said inner portion is connected to said outer portion of said cylindrical housing by way of said peripheral sloping surface;
said peripheral sloping surface runs at an angle (α1) of 15° to 45° in relation to the longitudinal mid-axis (a) of the venting unit.

21. The venting unit of claim 11, wherein:
said cylindrical housing includes an inner portion having an inner end; and,
said inner end has an outer side and has a sloping surface running at an angle (α2) of 10° to 60° in relation to the longitudinal mid-axis (a) of the venting unit.

22. The venting unit of claim 11, wherein:
said cylindrical housing includes an inner portion having an inner end; and,
said inner end has an outer side and has a sloping surface running at an angle (α2) of 15° to 45° in relation to the longitudinal mid-axis (a) of the venting unit.
